(19) United States
(12) Patent Application Publication
(10) Pub. No.: US 2009/0253542 A1
(43) Pub. Date: Oct. 8, 2009

(54) ROTARY DISC

(75) Inventor: Roman Kern, Forchheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/373,900

(22) PCT Filed: Aug. 7, 2007
(86) PCT No.: PCT/EP07/58170

§ 371 Date: Jan. 15, 2009

(30) Foreign Application Priority Data
Aug. 23, 2006 (DE) 20 2006 012973.1

(51) Int. Cl. F16H 55/30

(52) U.S. Cl. 474/141

(57) ABSTRACT

The configuration of teeth (20) and spacewidths (22) of a rotary disc (10) which is rotatable about a rotational axis (12) are provided. Here, the spacewidths (22) are in each case arranged symmetrically with respect to a spacewidth axis of symmetry (30), with a rotary disc radius being dependent on a rotational angle and a certain mean radius. The spacewidth axes of symmetry (30) of the rotary disc (10) are aligned towards the local centers of curvature, that is to say towards the center of curvature of the curve at the point at which the spacewidth axis of symmetry (30) intersects the peripheral line of the rotary disc (10). Formed around the rotational axis (12) is a circle axis (14) which is not intersected by any of the spacewidth axes of symmetry (30).

### BACKGROUND

The present invention relates to a rotary disc, in particular, to a configuration of the teeth and the spacewidths of the rotary disc. In addition, the present invention relates to a drive device with at least one rotary disc according to the invention and a looped traction element drive with at least one rotary disc according to the invention.

Driving systems on the basis of force-transmitting endless elements, such as, e.g., belts or chains, and gearwheels are very common in industrial applications. In particular, such driving systems are used in internal combustion engines for, e.g., transmitting a moment from the crankshaft to the camshafts.

In addition to the camshaft and the crankshaft, other components, such as, e.g., water or fuel pumps could also be driven by belts or chains. As a general term for belt and chain drives, one talks of so-called traction element drives.

So-called belt oscillations appear in such driving systems or traction element drives. Such belt oscillations can involve transversal, longitudinal, or torsional oscillations that are excited by cyclical motor movements in the force-transmitting endless element. The cyclical excitation of the belt oscillation is usually realized by a non-uniform driving element of the internal combustion engine.

In particular, the torsional oscillations or rotational angle oscillations of the individual, driven components relative to each other are considerable. Here, a so-called “timing error” appears, i.e., a twisting angle of the camshaft relative to the crankshaft. If this angular error is too large, when the motor is operated, emissions are generated beyond the permitted pollution limits.

In addition, for toothed belts a non-uniform load appears due to the rotational angle oscillations and this load leads to rips in the toothed belt and reduces the service life of the toothed belt in use.

Therefore, non-round gears have been proposed in order to compensate these belt oscillations and rotational angle oscillations. Non-round gears are to be understood as those gears that do not have a circular peripheral cross section and in which the effective curve or the loop-around arc of the force-transmitting endless element is not circular.

For example, the laid-open patent application DE 10 2004 048 629 A1 describes a non-round rotary disc of a control drive. The rotary disc here has a rotary disc radius that depends functionally on the rotational angle and on an average radius, wherein the average radius is selected so that a circumferential arc length of a rotary disc loop-around curve is equal to the product from the given distance of the center points of adjacent teeth and the number of teeth.

In addition, the utility model DE 202 20 367 U1 describes a synchronous drive device with a plurality of rotors that are coupled with each other by a force-transmitting endless element, wherein one of the rotors has a non-circular profile with at least two projecting sections that alternate with recessed sections, wherein the angular positions of the projecting and recessed sections of the non-circular profile and the extent of eccentricity of the non-circular profile are such that the non-circular profile applies an opposite, oscillating, correcting torque to the force-transmitting endless element that reduces an oscillating load torque of a load structure or is essentially cancelled.

In the operation of these proposed rotary discs or the proposed synchronous drive devices, it has been shown that the rotational angle oscillations can indeed be essentially compensated, despite, however, the appearance of high belt wear. The high belt wear, in turn, makes short service intervals necessary and leads to high maintenance costs of the relevant systems.

For moment compensation and for compensating the rotational angle oscillations, previously used non-round shapes are not adequate. A disc or tooth configuration that prevents the load peaks and that provides the most uniform possible “contact pattern” in the contact arc, i.e., the contact region between the belt and disc, is required.

### SUMMARY

The invention is based on the objective of providing a rotary disc or a drive device or a traction element drive in which fluctuations in rotational angle are compensated and in this way a significantly reduced wear of the force-transmitting endless element appears.

This objective is met by a rotary disc according to claim 1, a drive device according to claim 6, and a loop-around gear according to claim 10.

The rotary disc according to the invention can be rotated by a rotational angle about a rotational axis and comprises a number of teeth arranged on the periphery of the rotary disc and also spacewidths located between the teeth, wherein the spacewidths are each symmetric to a spacewidth axis of symmetry, and a rotary disc radius that is functionally dependent on the rotational angle and a defined average radius, and is characterized in that the spacewidth axes of symmetry are each directed essentially toward the local center of curvature of the periphery of the rotary disc.

It has been shown that the cause for high wear on the force-transmitting endless elements in the rotary discs of the state of the art is caused by large force spikes that are exerted by the gearwheel teeth on the endless element. The reason for this is the orientation and profiling of the circular gearwheels of the state of the art.

For a circular gearwheel, the spacewidths located between the teeth are each symmetric to a so-called spacewidth axis of symmetry. For circular gearwheels, each spacewidth axis of symmetry runs through the rotational axis or center of this circular gearwheel. The section of the gearwheel between two such spacewidth axes of symmetry is called a sector in the scope of this description.

In a circular gearwheel, all of the sectors are identical. By placing the sectors one against the other, a circular gearwheel is obtained. Here, the spacewidths have a continuous surface without discontinuities provided with tangential transitions between the sectors.

For the non-circular gearwheels of the state of the art, for the configuration it was also previously determined that all of the spacewidth axes of symmetry must run through the rotational axis of the gearwheel. For such gearwheels, however, identical sectors cannot be simply placed one next to the other. Instead, the sectors must be offset by a certain degree, in order to place the individual sectors along the non-circular periphery.

On the lines of spacewidth symmetry, however, the spacewidths now do not have transitions between the sectors like those for a circular gearwheel, but instead are more strongly curved or even have a discontinuity to the spacewidth axis of symmetry in this region. Therefore, the teeth are pointed at a larger angle from each other than for a circular gearwheel.

The spacewidth contours of the state of the art are distorted so that they generate an increased load in the tooth base of the force-transmitting endless element. In addition, increased wear appears on such contours.

According to the invention, however, the spacewidth axes of symmetry are not all directed toward the rotational axis, but instead each is essentially directed toward the local center of curvature of the periphery of the rotary disc, i.e., they are perpendicular to the contours of the non-round wheel. The spacewidth axes of symmetry then as a rule no longer run through the rotational axis. Then the usually asymmetric tooth geometry is defined by the spacewidths that are kept equal. The flank contours of the tooth are given from the form of the adjacent spacewidths. The head contour of the tooth is given from the geometry of the contours of the active line.

Through the alignment according to the invention for the spacewidth axes of symmetry toward each local center of curvature, symmetric spacewidth geometries are generated with continuous transitions between the sectors in the spacewidths. In addition, the problem of increased wear is avoided. The run-in and run-out of the force-transmitting endless element is realized in a friction-reduced and wear-reduced way, because the pressure due to the transmission of forces from the teeth to the force-transmitting endless element is now distributed uniformly and force spikes are prevented. In this way, the rotary disc according to the invention discloses a significant advantage relative to the state of the art.

In one embodiment, it can be provided that the periphery of the rotary disc is essentially non-round. The spacewidth axes of symmetry are perpendicular to the contours of the non-round rotary disc.

In one embodiment of the invention it can be provided that the rotary disc radius can be expressed by a harmonic series of the following form:

$$r ( t ) = {r}_{mittel} + {\sum }_{i} δ {r}_{i } cos ( {n}_{i} t + {ϕ}_{i} )$$

where rₘᵢₜₜₑₗ is the average radius, δrᵢ is a non-roundness amplitude, nᵢ is a number of raised sections, φᵢ is a phase position, and t is a running parameter from an interval of 0 to 2π. The average radius is here selected suitably as a function of the other parameters, so that a desired length of the loop-around curve of the rotary disc is given. The number of raised sections is also designated as the order. As is to be seen, several angle-dependent interference elements of different orders can also be superimposed on the average radius. If no interference element is provided, a circular rotary disc is obtained. Accordingly, it is provided that at least one interference element is also present.

If each parameter δrᵢ is set equal to zero, a circular rotary disc is also obtained. Accordingly, it is provided according to the invention that each parameter δrᵢ is equal to a non-zero number.

In another embodiment, it can be provided that the teeth are constructed for involute gear teeth.

It can be provided that the spacewidth axes of symmetry are oriented so that a circular area concentric to the rotary disc is not intersected by the spacewidth axes of symmetry that do not run through the rotational axis. The circular area can have a diameter of approximately 0.1 mm to approximately 20 mm and, in particular, a diameter from approximately 0.5 mm to approximately 6 mm.

A drive device according to the invention comprises at least two rotary discs and a force-transmitting endless element for transmitting a moment between the rotary discs and is characterized in that at least one of the rotary discs is a rotary disc according to the invention. In this way, increased wear of the force-transmitting endless element is also prevented in the drive device according to the invention.

In addition, the drive device according to the invention can be constructed for use in a motor vehicle.

Alternatively, the drive device can be constructed for use in aircraft.

In one embodiment, the drive device according to the invention is a synchronous drive device.

The loop-around gear according to the invention comprises at least two rotary discs and a force-transmitting endless element for transmitting a moment between the rotary discs and is characterized in that at least one of the rotary discs is a rotary disc according to the invention. In this way, increased wear of the force-transmitting endless element is also prevented in the loop-around gear according to the invention.

Additional advantages and configurations of the invention emerge from the description and the accompanying drawing.

It is understood that the features named above and the features still to be explained below can be used not only in each specified combination, but also in other combinations or by themselves, without leaving the scope of the present invention.

### BRIEF DESCRIPTION OF THE DRAWINGS

The invention will be explained in greater detail below with reference to an embodiment. Shown in the associated drawing are:

FIG. 1 a cross-sectional view of a non-circular gearwheel for compensating rotational angle fluctuations and belt oscillations of the state of the art,

FIG. 2 an enlarged view of a region of a non-circular gearwheel of the state of the art in FIG. 1,

FIG. 3 a cross-sectional view of a rotary disc according to the invention in a preferred embodiment,

FIG. 4 an enlarged view of a region about the rotational axis of the rotary disc in FIG. 3,

FIG. 5 a cross-sectional view of an embodiment of a rotary disc according to the invention whose radius is formed from the superposition of an average radius with an interference element of third order and an interference element of sixth order, and

FIG. 6 an enlarged view of a region A about the rotational axis of the rotary disc in FIG. 5.

### DETAILED DESCRIPTION OF THE PREFERRED EMBODIMENTS

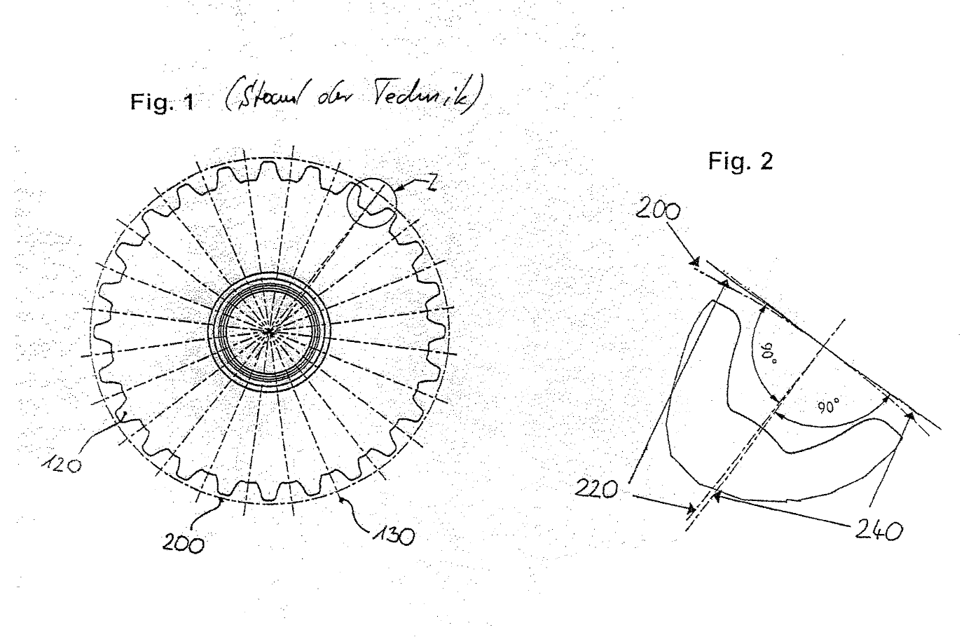

FIGS. 1 and 2 show a rotary disc 110 of the state of the art. The rotary disc 110 of the state of the art has a non-circular cross section for compensating fluctuations in rotation or rotational angle. A number of teeth 120 are arranged along the periphery of the rotary disc 110. The rotary disc 110 rotates about a rotational axis 112. Spacewidths located between the teeth 120 are each symmetric to each other relative to a spacewidth axis of symmetry 130. The rotary disc 110 is located along an active curve 200 engaged with a force-transmitting endless element (not shown).

So that the individual sectors of the rotary disc 110 located between two spacewidth axes of symmetry 130 match each other despite the non-circular cross section, they must be modified or offset. Therefore, transitions with discontinuities are produced at the transitions between the teeth 120 to the spacewidth axes of symmetry 130. Through this offset, the problem of increased wear cited in the introduction of the description appears.

For comparison, in FIG. 2 a spacewidth axis of symmetry is shown with associated tangent 220 that runs through the rotational axis 112 and also follows a spacewidth axis of symmetry with associated tangent 240 that does not run through the rotational axis 112 according to the present invention, but instead is perpendicular to the tangent and is directed toward the local center of curvature.

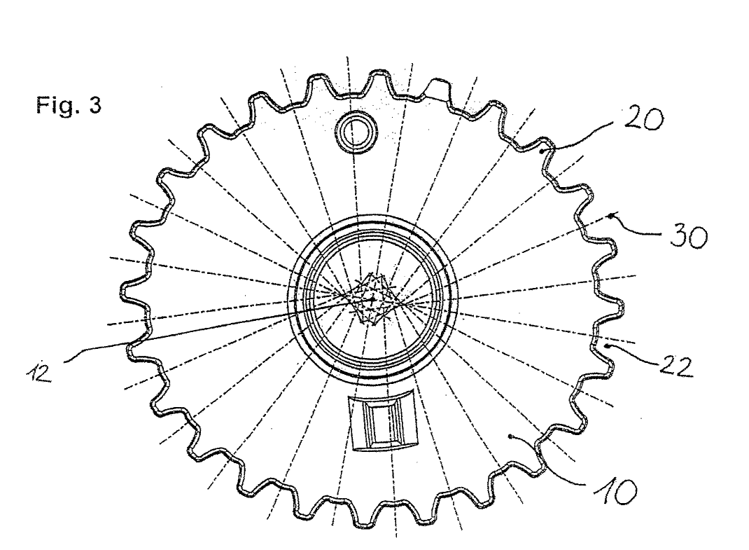

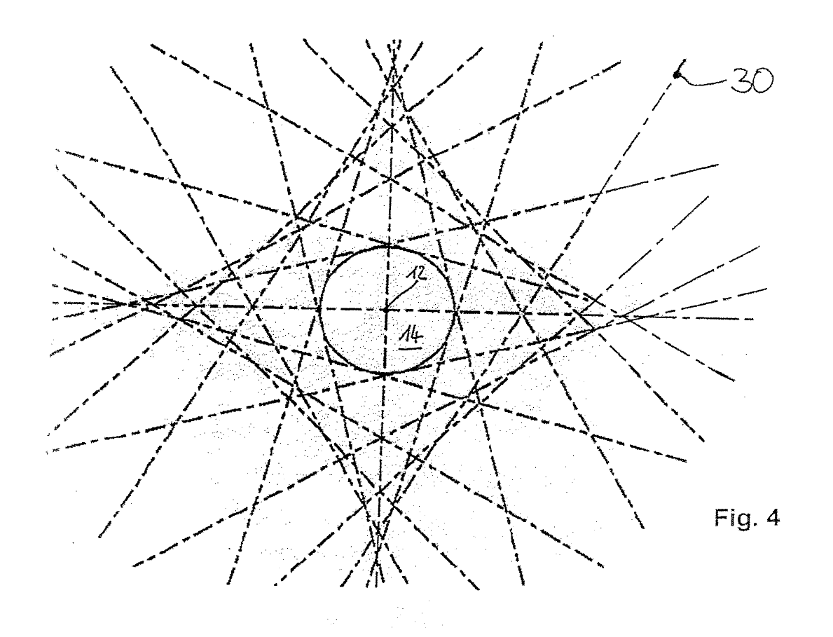

FIGS. 3 and 4 show a rotary disc 10 according to the invention that rotates about a rotational axis 12. A number of teeth 20 are arranged along the periphery of the rotary disc 10. Spacewidths 22 located between the teeth 20 are symmetric to each other along a spacewidth axis of symmetry 30. As is to be seen, for the rotational disc 10 according to the invention, the spacewidth axes of symmetry 30 are not directed toward the rotational axis 12. The spacewidth axes of symmetry 30 are instead directed toward the local centers of curvature, i.e., toward the center of curvature at the point at which the spacewidth axis of symmetry 30 intersects the peripheral line of the rotary disc. Therefore, a circular area 14 that is intersected by none of the spacewidth axes of symmetry 30 is formed about the rotational axis 12.

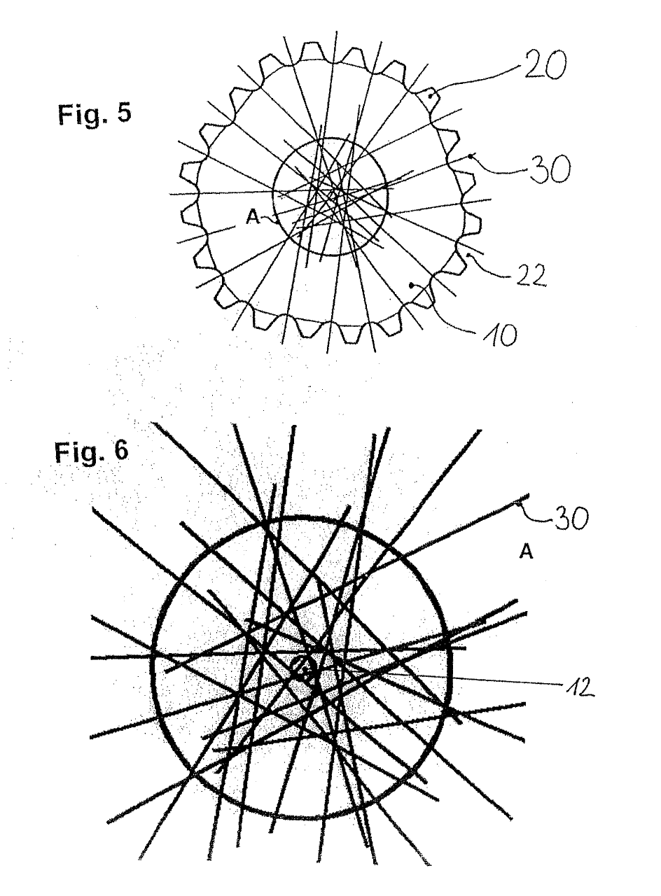

FIGS. 5 and 6 show a rotary disc 10 according to the invention in another embodiment. The rotary disc radius is formed from an average radius that is superimposed by an interference element of third order and an interference element of sixth order in a manner according to the invention. FIG. 6 shows the profile of the spacewidth axes of symmetry 30 in the vicinity of the rotational axis 12.

Through the rotary discs 10 according to the invention, a symmetric configuration of the spacewidths 22 along the periphery of the rotary disc 10 is possible without an offset and with continuous transitions of the spacewidths to the spacewidth axes of symmetry 30. The contours of the teeth 20 are given from the positions of the spacewidths 22 and the contours of the active line of the rotary disc 10.

Thus, a uniform pressure of a force-transmitting endless element applied to the rotary disc 10 against the teeth 20 is enabled and a run-in and run-out of the force-transmitting endless element is realized in a friction-reduced and wear-reduced way. Force spikes exerted by the teeth 20 do not appear on the force-transmitting endless element. In this way, the wear of the force-transmitting endless element is significantly reduced relative to the state of the art, wherein longer service intervals and thus lower maintenance costs of the systems in which the rotational disc according to the invention is used are enabled.

The rotary disc according to the invention is advantageously used in a synchronous drive device or in a traction element drive. The synchronous drive device or the traction element drive is advantageously constructed for use in a motor vehicle or in aircraft. The rotary disc according to the invention, however, can also be used independent of these applications or also in textile or office machines.

### LIST OF REFERENCE SYMBOLS

10 Rotary disc
12 Rotational axis
20 Teeth
22 Spacewidths
30 Spacewidth axes of symmetry
110 Rotary disc (state of the art)
112 Rotational axis (state of the art)
120 Teeth (state of the art)
130 Spacewidth axes of symmetry (state of the art)
200 Active curve (state of the art)
220 Spacewidth axis of symmetry through rotational axis with associated tangent (state of the art)
240 Spacewidth axis of symmetry outside of rotational axis with associated tangent

1. Rotary disc that can rotate about a rotational axis by a rotational angle comprising a number of teeth arranged on a periphery of the rotary disc and also spacewidths located between the teeth, the spacewidths are each symmetric to a spacewidth axis of symmetry and a rotary disc radius that is dependent on the rotational angle and a defined average radius, and the spacewidth axes of symmetry are each directed essentially toward a local center of curvature of the periphery of the rotary disc.

2. Rotary disc according to claim 1, wherein the periphery of the rotary disc is essentially non-round.

3. Rotary disc according to claim 1, wherein the rotary disc radius can be expressed by a harmonic series of the following form:
$$r ( t ) = {r}_{mittel} + {\sum }_{i} δ {r}_{i } cos ( {n}_{i} t + {ϕ}_{i} )$$
where:
rₘᵢₜₜₑₗ=average radius,
δrᵢ=a non-roundness amplitude,
nᵢ=number of raised sections,
φᵢ=a phase position, and
t=a running parameter from an interval of 0 to 2π.

4. Rotary disc according to claim 1, wherein the teeth are constructed as involute gear teeth.

5. Rotary disc according to claim 1, further comprising a circular area concentric to and located on the rotary disc that is not intersected by the spacewidth axes of symmetry that do not run through the rotational axis, and the circular area has a diameter of approximately 0.1 mm to approximately 20 mm.

6. Rotary disc according to claim 5, wherein the circular area has a diameter of approximately 0.5 mm to approximately 6 mm.

7. Drive device with at least two rotary discs and a force-transmitting endless element for transmitting a force between the rotary discs at least one of the rotary discs is a rotary disc that can rotate about a rotational axis by a rotational angle comprising a number of teeth arranged on a periphery of the rotary disc and also spacewidths located between the teeth, the spacewidths are each symmetric to a spacewidth axis of symmetry and a rotary disc radius that is dependent on the rotational angle and a defined average radius, and the spacewidth axes of symmetry are each directed essentially toward a local center of curvature of the periphery of the rotary disc.

8. Drive device according to claim 7, which is constructed for use in a motor vehicle.

9. Drive device according to claim 7, which is constructed for use in aircraft.

10. Drive device according to claim 7, wherein the drive device comprises a synchronous drive device.

11. Traction element drive with at least two rotary discs and a force-transmitting endless element for transmitting a force between the rotary discs at least one of the rotary discs is a rotary disc that can rotate about a rotational axis by a rotational angle comprising a number of teeth arranged on a periphery of the rotary disc and also spacewidths located between the teeth, the spacewidths are each symmetric to a spacewidth axis of symmetry and a rotary disc radius that is dependent on the rotational angle and a defined average radius and the spacewidth axes of symmetry are each directed essentially toward a local center of curvature of the periphery of the rotary disc.
